(19) United States
(12) Patent Application Publication
(10) Pub. No.: US 2005/0044250 A1
(43) Pub. Date: Feb. 24, 2005

(54) File transfer system

(76) Inventors: Lance Jeffrey Gay, Torrance, CA (US); Timothy Alan Yokote, Torrance, CA (US)

Correspondence Address: Christopher P. Harris;1111 Leader Building, 526 Superior Avenue, Cleveland, OH, 44114, US

(21) Appl. No.: 10/630,601

(22) Filed: Jul. 30, 2003

(51) Int. Cl. G06F 15/16

(52) U.S. Cl. 709/230

(57) ABSTRACT

Systems and methods are provided for efficiently transferring a file between two entities. A client system includes a file partitioner that divides a file into a plurality of blocks. A client control application initiates a plurality of Transmission Control Protocol (TCP) connections. Each of the blocks is assigned to a TCP connection. Each block is transmitted via its assigned connection. A server system includes a server control application operative to monitor a plurality of TCP connections. The server receives a plurality of blocks via the TCP connections and writes the block to a file at the server system.

### CROSS REFERENCE TO RELATED APPLICATIONS

The present application is related to Mori, et al. U.S. patent application entitled “Methodology For Fast File Transfer Protocol”, Ser. No.: 10/005,770, Filed Nov. 8, 2001.

### TECHNICAL FIELD

This invention relates to data transmission and more particularly relates to fast and reliable transmission of files from one computer system to another computer system.

### BACKGROUND OF THE INVENTION

A common protocol for computer networks is TCP/IP, which is the protocol used for data transmission on the Internet. TCP stands for Transmission Control Protocol, and IP stands for Internet Protocol. TCP is a transport protocol that is responsible for end-to-end delivery of information across an internetwork (i.e., a network of networks). File transfer applications depend on TCP for reliable delivery as TCP is a connection-oriented acknowledged transport protocol.

Connection-oriented implies that TCP first establishes a connection between two systems that intend to exchange data. Since most networks are built on shared media (for example, several systems sharing the same cabling), it is often necessary to break data into manageable pieces so that no two communicating computers monopolize the network. These pieces are called packets. When an application sends a message (file or data) to TCP for transmission, TCP breaks the message into packets, sized appropriately for the network, and sends the packets over the network. TCP can use port IDs to specify which application running on the system is sending or receiving the data. The port ID, checksum, and sequence number can be inserted into the TCP packet in a section called the header. The header is at the beginning of the packet containing this and other “control” information for TCP.

Prior art applications can take a large amount of time to transfer a file. For example, transferring a large file (e.g., 2 Gigabyte file) across a great distance (such as a transfer between continents), can require upwards of 20 to 40 hours. A significant portion of this time can be attributed to the TCP packet acknowledgement process. For long distance transfers, it can take approximate 500 milliseconds for transmission of a packet and the return receipt of the acknowledgement back to the originating system. In a TCP transmission, the time required for the acknowledgement is dead time, during which no data is transmitted. Mitigating the effect of this acknowledgement process would decrease the file transfer time.

### SUMMARY OF THE INVENTION

The following presents a simplified summary of the invention in order to provide a basic understanding of some aspects of the invention. This summary is not an extensive overview of the invention. It is intended neither to identify key or critical elements of the invention nor delineate the scope of the invention. Its sole purpose is to present some concepts of the invention in a simplified form as a prelude to the more detailed description that is presented later.

In accordance with one aspect of the invention, a client system is disclosed for transmitting a file. A file partitioner divides a file into a plurality of blocks. A client control application is operative to initiate a plurality of Transmission Control Protocol (TCP) connections. The client control application assigns each of the plurality of blocks to one of the plurality of Transmission Control Protocol connections, such that each block is transmitted via an assigned connection.

In accordance with another aspect of the invention, a server system is provided. A server control application is operative to monitor a plurality of Transmission Control Protocol connections and to receive a plurality of blocks via the plurality of Transmission Control Protocol connections. Each block has an associated ordinal identifier. A buffer stores the received blocks. A concatenation control retrieves a received block from the buffer and concatenates it with at least one other block having an ordinal identifier prior to the received block. A received block is concatenated once all blocks having an ordinal identifier prior to the received block have been received.

In accordance with yet another aspect of the invention, a method is provided for transferring a file over a network. A source file is divided into a plurality of blocks at a first entity. A plurality of data connections are established with a second entity. The plurality of blocks are assigned to the plurality of data connections. The blocks are transmitted from the first entity to the second entity. Each block is transmitted over its assigned data connection.

In accordance with still another aspect of the present invention, a method is provided for transferring a file from a first entity to a second entity over a network. A plurality of blocks are transmitted from the first entity to the second entity via a plurality of data connections. A sequence of blocks including a first block are concatenated into a file during the transmission of at least one other block within the sequence. A block received at the second entity is concatenated when all blocks having an ordinal identifier prior to the received block have been concatenated into the file. A block received at the second entity is buffered when at least one block having an ordinal identifier prior to the received block has not been concatenated into the file.

To the accomplishment of the foregoing and related ends, certain illustrative aspects of the invention are described herein in connection with the following description and the annexed drawings. These aspects are indicative, however, of but a few of the various ways in which the principles of the invention can be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates two computer systems coupled together by a communications network.

FIG. 2 is a block diagram of a computer system in which at least a portion of the present invention can be embodied.

FIG. 3 illustrates a chart of software layers associated with a TCP/IP stack in accordance with one or more aspects of the present invention.

FIG. 4 illustrates a functional block diagram of an internetwork file transfer between a client system and a server system in accordance with one or more aspects of the present invention.

FIG. 5 illustrates a block diagram of an internetwork file transfer in accordance with one or more aspects of the present invention.

FIG. 6 illustrates a screenshot of a graphical user interface from a client system in accordance with one or more aspects of the present invention.

FIG. 7 illustrates a screenshot of a graphical user interface from a server system in accordance with one or more aspects of the present invention.

FIG. 8 is a flowchart illustrating a method for transmitting a file in accordance with one or more aspects of the present invention.

FIG. 9 is a flowchart illustrating a method for receiving a file in accordance with one or more aspects of the present invention.

### DETAILED DESCRIPTION OF INVENTION

Systems and methods are provided for transferring a file from a first entity to a second entity across a network. The file is divided into a plurality of blocks and transmitted via a plurality of parallel data connections. In accordance with one aspect of the present invention, a first one of the plurality of blocks can be transmitted via a first data connection while a second one of the plurality of blocks is being transferred via a second data connection. The data connections can utilize Transmission Control Protocol (TCP). The plurality of blocks are concatenated, or written, at the second entity. In accordance with an aspect of the invention, one or more blocks can be concatenated at the second entity, while one or more other blocks are being transferred across the network.

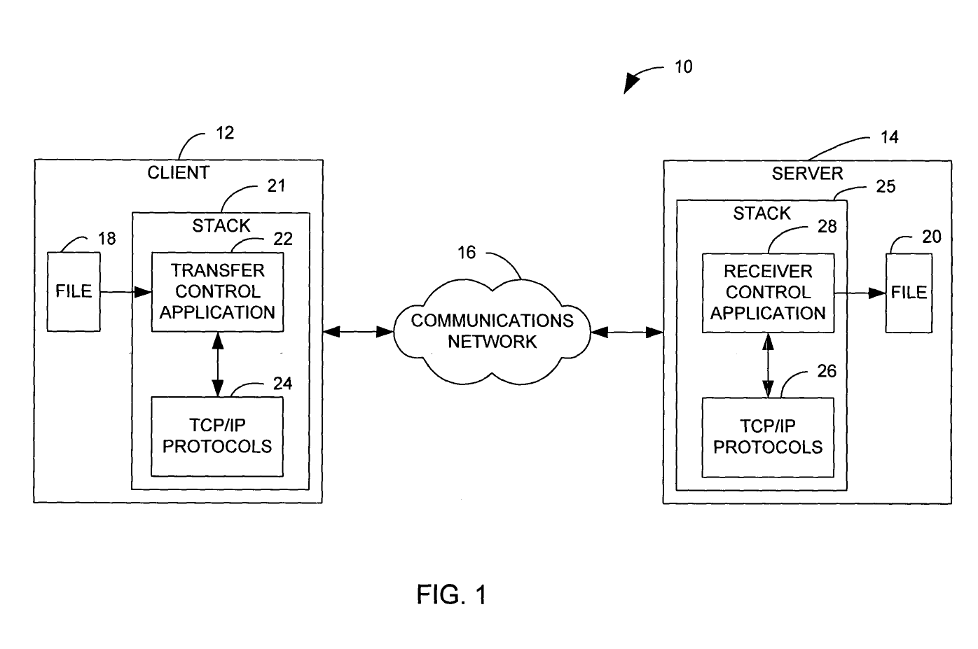

FIG. 1 illustrates an intersystem file transfer 10 between a first entity system 12 and a second entity 14 that can be coupled together by a communications network 16. The first and second entities can comprise any of a variety of data processing machines. For example, the communications network 16 can be a computer network (e.g., a LAN, a WAN or the internet), a wireless network (e.g., a cellular data network), some combination of these two types of communication mediums or some other communication medium.

In the illustrated application, it is desired to transmit the contents of a source file 18 located at the first entity 12 to a destination file 20 at the second entity 14. The source file is provided to a first internetwork protocol stack 21. Within the stack, a transfer control application 22 prepares the file for transfer using a first set of TCP/IP protocols 24 within the stack 21 to establish a connection with the communications network 16 and transmit the file. For example, the first set of TCP/IP protocols 24 can include internetwork addressing protocols to allow the first entity 12 to locate a network associated with the second entity 14. Similarly, the first set of TCP/IP protocols can include transfer protocols to manage the transmission of the file to a desired location, such as the second entity 14.

At the second entity 14, the file is received at a second internetwork protocol stack 25 comprising a second set of TCP/IP protocols 26 compatible with the first set of TCP/IP protocols 24. The second set of TCP/IP protocols can include transfer protocols to manage the reception of the file and to provide acknowledgements for the received data. The second internetwork protocol stack 25 further comprises a receiver control application 28 that utilizes the second set of TCP/IP protocols 26 to establish and maintain a connection with the first entity 12. The receiver control application 28 writes the received data to the destination file 20, and closes the connection with the first entity 12 upon completion of the transmission.

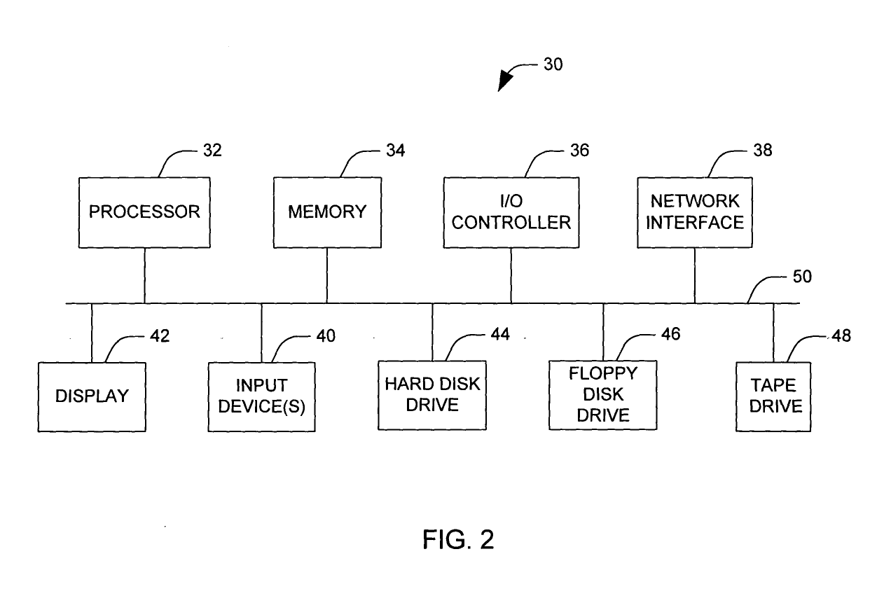

FIG. 2 is a block diagram of a computer system 30 that can be located within the first entity 12 or the second entity 14, and in which a portion of the present invention can be embodied. Thus, the computer system 30 can represent either a transmitting entity or a receiving entity in a file transfer. Other embodiments and configurations of the computer system are also within the scope of the present invention. More particularly, the computer system can be a computer such as a PC or workstation running on any of a variety of operating systems. The computer system 30 can include a processor unit 32, a main memory unit 34 for storing programs and/or data, an input/output controller 36, and a network interface 38 for enabling network communications. The computer system 30 can further include one or more input devices 40, such as a keyboard or mouse, a display device 42, a fixed or hard disk drive unit 44, a floppy disk drive 46, a tape drive 48 and a data bus 50 coupling all of the components (32-48) to allow communication therebetween. The configuration of the computer system is not limited to the configuration shown in FIG. 2.

One or more computer programs can define the operational capabilities of the computer system. The computer programs can be loaded into a computer system via the hard disk drive 44, the floppy disk drive 46 and/or the tape drive 48. Alternatively, the computer programs can reside in a permanent memory location (e.g., a ROM chip) of the main memory 34. For example, a transmitting entity, such as the client in a file transfer, can include a hard drive with control software and various network communication protocols. Similarly, a receiving entity can include a hard drive with dedicated buffer space, one or more network communication protocols compatible with those of the transmitting entity, and control software suited to managing the reception and reintegration of data.

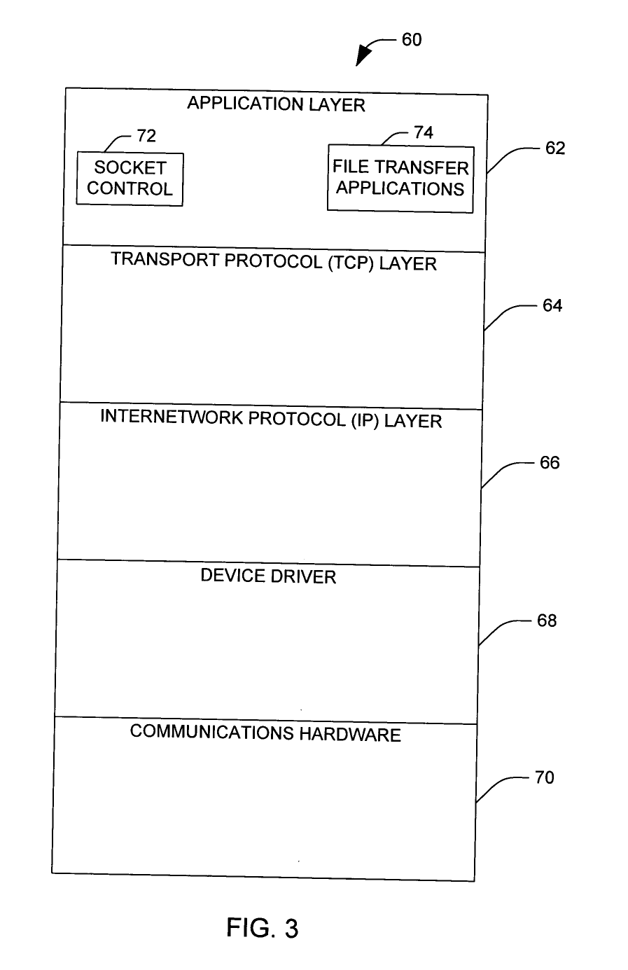

FIG. 3 illustrates a TCP/IP protocol stack 60 that can be utilized for file transmission in accordance with an exemplary implementation of the present invention. The TCP/IP protocol stack 60 can be implemented as software in both a client and a server application to facilitate the exchange of data between them. Other implementations are also within the scope of the present invention. More specifically, FIG. 3 shows an application layer 62, a transport protocol (TCP) layer 64, an internetwork protocol (IP) layer 66, a device driver 68 and communications hardware 70. As is well known, the communications hardware 70 is the physical means (e.g., the electrical, mechanical and functional control of data circuits) of sending data over a communication medium. The transport protocol layer 64 can correspond to well known layers in the art.

The application layer 62 can contain functions for particular application services such as file transfer, remote file access and virtual terminals. For example, the application layer 62 can contain a socket control 72 that provides high-level control over a plurality of network communication ports within the system. Software applications 74 in accordance with one or more aspects of the present invention can also be provided within the application layer 62. The application layer 62 at each of a plurality of client and server systems can comprise software containing program instructions to perform features of the present invention as will be described below.

As discussed above, one problem with known file transfer applications is that latent networks, that is networks requiring a comparatively long interval of time to send and receive data packets, reduce transfer rates. That is, a file transfer over a latent network involves sending packets from the originating system and transmitting an acknowledgment back to the originating system before subsequent packets can be sent from the originating system. This process can consume a significant amount of time on a latent network.

In accordance with one aspect of the present invention, a client, comprising a computer system such as that described in FIG. 2, can divide a large file into multiple pieces (or blocks) and transfer each of the blocks over the network, rather than executing a single transfer of a large file. The connection through the communications network 16 of FIG. 1 includes a plurality of TCP connections governed by a control application. The blocks can be reassembled at the server system are reconstructed into a destination file as they are being transferred. Concatenation control software at the server controls the activity of the transfer and the rebuilding of the file blocks. The files can correspond to any number of types of files including data files, program files and visual files. Embodiments of the present invention are applicable to full motion visual products including the audio and video content, as well as other file data types.

In an exemplary implementation, each block is roughly the same size, although a final block can contain control information, making it slightly larger. Each block can be assigned to one of a plurality of TCP connections and transmitted across the network. The Internet Protocol (IP) address of the receiving system can also be passed to the application layer 62. This IP address gives the internetwork location of the receiving system to the transmitting application. A control file can also be transmitted to assist in assembly of the blocks at the receiving system. On the receiving system, a separate application can be launched to maintain and monitor the plurality of TCP connections and to reassemble the transferred file. Therefore, when a block reaches the receiving system, the receiving system can concatenate the received block into a destination file.

By utilizing embodiments of the present invention, the TCP layer 64 does not change its normal operational mode. That is, the TCP layer 64 still waits for periodic acknowledgments from the second computer system 30 regarding the transmitted packets. However, the present invention maximizes the use of the available bandwidth by concurrently transmitting blocks across multiple data connections within the network. The last block of a file can comprise a control block that contains information regarding the transferred file such as the file size, the correct bit length and all the other pieces. Embodiments of the present invention are also applicable to the control block being located in blocks other than the last block of the file or being sent as a separate control transmission.

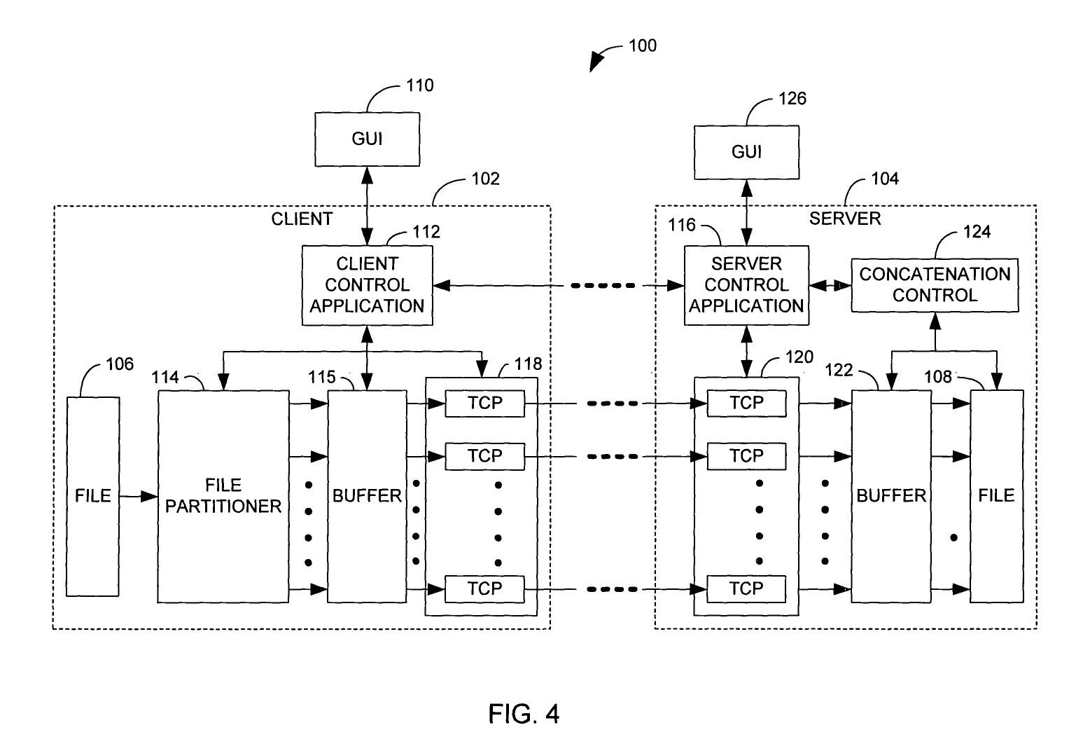

FIG. 4 illustrates a functional block diagram of an internetwork file transfer 100 between a client system 102 and a server system 104 in accordance with one or more aspects of the present invention. The internetwork file transfer 100 includes transmitting a source file 106 from the client system through a plurality of data connections to a destination file 108 created at the server system 104. The internetwork file transfer 100 utilizes a given quantity of bandwidth in an efficient manner to provide data more quickly than prior art transfer protocols.

The file transfer can be initiated by a user through a graphical user interface 110. In response to a user command, a client control application 112 will direct a file partitioner 114 to divide the source file 106 into a plurality of data blocks. In an exemplary embodiment, each of these blocks is roughly equal in size. Each block represents a portion of the file data such that when the blocks are reconstructed in sequence, they provide the entire contents of the source file. The blocks are encoded with ordinal identification data representing their appropriate position in the sequence and stored in a buffer 115.

The client control application establishes a TCP connection with the server 104. The client control application 112 provides configuration data to the server 104 for the file transfer. In accordance with an aspect of the present invention, this configuration data will include a proposed number of TCP connections to be opened between the client 102 and the server 104, as well the size of the source file 106 and the number of blocks formed from the source file. The appropriate number of TCP connections to be used in the transfer can be designated by the user or determined by the client control application according to the available bandwidth for the transfer.

The configuration information is received at the server 104 and provided to a server control application 116. The server control application 116 prepares the server to accept the destination file 108 and returns an acknowledgement to the client 102. Upon receipt of the acknowledgement, the client control application 112 opens a desired number of TCP connections with the server at a plurality of sockets 118. The server application control 116 assigns an equal number of sockets 120 at the server to receive the transferred data.

An initial set of blocks from the buffer 115 are assigned to the TCP connections such that each connection is assigned one block. In an exemplary embodiment, subsequent blocks can be assigned to the TCP connections in sets, with a new set assigned at the completion of the transfer of each set. Where errors delay the transmission of one block in the set, the other connections pause to allow the lagging connection full access to the available bandwidth. Alternatively, subsequent blocks can be assigned to each connection as it becomes available to maintain continuous transmission of the source file 106 and to maximize bandwidth associated with the transmission.

The blocks, in accordance with known TCP operation, are transmitted as a series of packets. Each TCP connection transmits a predetermined amount of data (e.g., two packets), and pauses to receive an acknowledgement from the server 104. If the acknowledgement is received, the TCP connection continues to send packets of data. If the acknowledgement is not received, the client 102 retransmits the unacknowledged data. A block has been completely transferred when all of the packets comprising the block have been received at the server 102.

As blocks are received at the server, they are stored in a buffer 122. A concatenation control 124 monitors the buffer to reconstruct the file in the appropriate sequence. When the first block in the sequence is stored in the buffer 122, the concatenation control 124 writes the block as the initial portion of the destination file 108. As each successive block arrives, it is concatenated into the file in its appropriate position. When a block arrives out of sequence, it is stored in the buffer 122 until it is required. Thus, the reconstruction of the file can begin before all of the blocks have been transmitted. Once a block has been written into the destination file 108, the space within the buffer 122 occupied by the block can be erased or overwritten with subsequent blocks. This allows the buffer 122 to be considerably smaller than the size of the file.

Due to the partitioned nature of the file transfer, the system can provide accurate updates of the transfer process. The system can notify users of the progress of the file transfer at a graphical user interface 110 at the client 102 and an optional graphical user interface 126 at the server 104. In an exemplary embodiment, the client can send periodic e-mail updates to interested parties notifying them of the progress of the transfer. For example, these e-mails can include estimates of the time required for completion based upon the aggregate size of the blocks remaining to be transferred and the average transfer rate over a particular time period selected by the user. A plurality of e-mail addresses can be provided as configuration data by a user for this purpose when the transfer is initiated.

The present system is also robust against errors in transmission. When a transfer is interrupted by an unforeseen event, such as a power outage or a system crash on either end, the transfer can reinitiated by the client. After such an event, the client will attempt to reconnect to the server and resume the connections at fixed intervals. Once one or more connections are reestablished, the transfer is resumed at the point of disturbance.

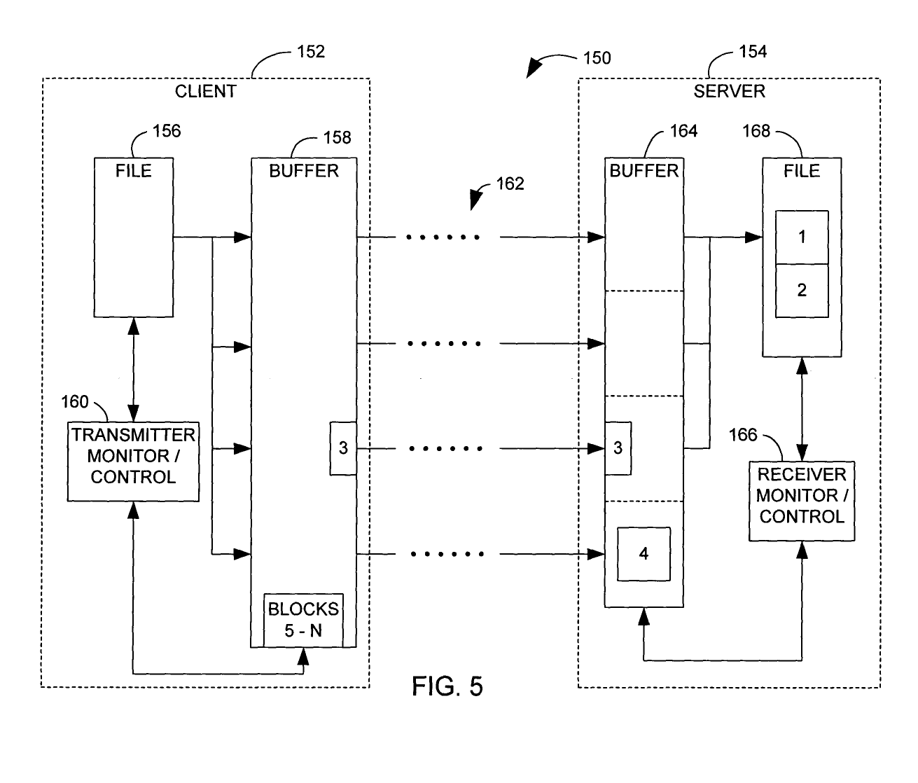

FIG. 5 illustrates a block diagram of an internetwork file transfer 150 between a client system 152 and a server system 154 in accordance with one or more aspects of the present invention. A source file 156 on the client 152 is broken up into a sequence of blocks. Each of the blocks contains ordinal identification information identifying its location in the sequence. The blocks are stored in a buffer 158. A transmitter control/monitor application 160 assigns a block to each of a plurality of TCP connections 162 for transmission to the server 154. In the illustrated example, four TCP connections are illustrated, but it will be appreciated that any plural number of connections can be utilized for the transfer 150 within the spirit of the present invention.

Initially, the blocks are assigned in a round-robin arrangement, with the blocks assigned in sequence to the plurality of TCP connections 162 until a block has been assigned to each of the connections. The TCP connections 162 then transmit their assigned blocks to the server 152 where they are stored within a buffer 164. The transmitter control/monitor application 162 monitors the transmissions to determine when the transfer of each block has finished, and then assigns new blocks to the plurality of connections. In an exemplary embodiment, the blocks can be assigned to the TCP connections 162 in sets using the round robin allocation of the initial transfer, such that a new set assigned at the completion of the transfer of each set. Where errors delay the transmission of one block in the set, the other connections pause to allow the lagging connection full access to the available bandwidth. Alternatively, the blocks can be assigned to a respective connection as it completes its previous transmission to maintain continuous transmission of the source file 156 at each connection. Furthermore, in one implementation, blocks can be reassigned to faster connections in real-time to facilitate the speed of the overall transmission.

At the server 154, a receiver monitor/control application 166 monitors the buffer to determine when blocks have been received. As blocks within the sequence are received, they are retrieved from the buffer 164 and concatenated into a destination file 168 in their original sequence. This process can be complicated by transmission errors, network slowdowns, and other glitches within one or more TCP connections that cause one or more blocks to arrive out of sequence. Thus, the receiver monitor/control application 166 reviews an ordinal identifier associated with each block that indicates its position within the sequence. This ensures that no block is concatenated into the file until every previous block has been concatenated.

In the illustrated example, blocks one and two have been received at the server. At the illustrated instant of the transfer 150, the receiver monitor/control application 166 has already located blocks one and two within the buffer and concatenated them into the destination file 168. Block four has already arrived and is stored in the buffer 166, but cannot be concatenated into the file until all prior blocks in the sequence have arrived. This has not occurred, as block three is still in transit between the client 152 and the server 154. Upon the completion of the transfer of block three, both block three and block four will be retrieved from the buffer and concatenated into the destination file.

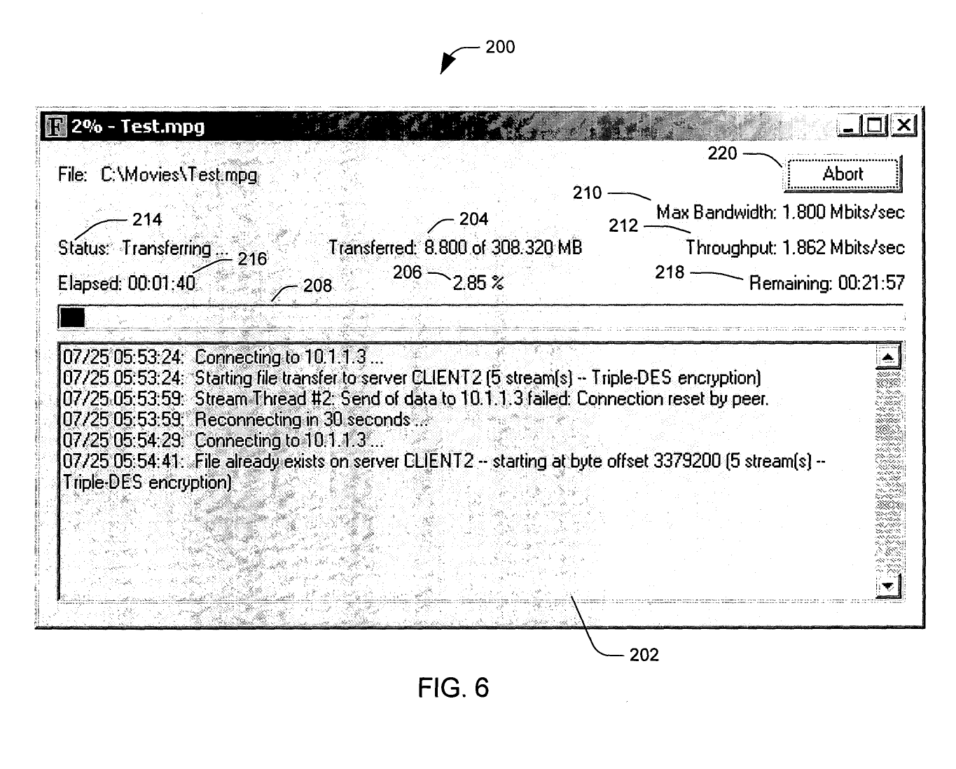

FIG. 6 illustrates a screenshot from an exemplary graphical user interface 200 for the client. The graphical user interface 200 provides status messages to a user within an update window 202. The graphical user interface provides further provides both a raw numerical indication 204 of the progress of the transfer, as well as a relative indication 206 of the transfer progress in the form of a percentage. A relative indication of the transfer progress is also provided graphically in the form of a status bar 208. The graphical user interface 200 also provides a status data for the transfer, such as the maximum bandwidth allowed for the transfer 210, the throughput of the transfer 212, and the present status 214 of the transmission (e.g., transferring, error, complete, etc.). The maximum bandwidth 210 can be set at a value less than the bandwidth available for the transmission to allow other applications to make user of the network capacity of the client. The graphical user interface 200 also displays the elapsed time 216 for the transmission as well as an estimate of the remaining time to completion of the transmission 218. This estimate is derived from the quantity of file data remaining to be transferred and an average transfer speed taken over a user defined period.

The graphical user interface includes an abort key 220 that allows the user to end the transmission. Additional functionality not shown herein can be provided by means of pull-down or “right-click” menus within the interface 200. For example, additional menus can be provided for providing more detailed information about each of the streams involved in the transfer. These menus can also allow access to a configuration routine that allows a user to enter configuration data for the transmission. In an exemplary embodiment, the user can specify a maximum bandwidth to be used in the connection, an averaging period used for deriving a transmission speed in an estimate of the remaining duration of the transfer, and a number of streams for the transfer. Other configuration parameters can be provided, according to the requirements of a particular application.

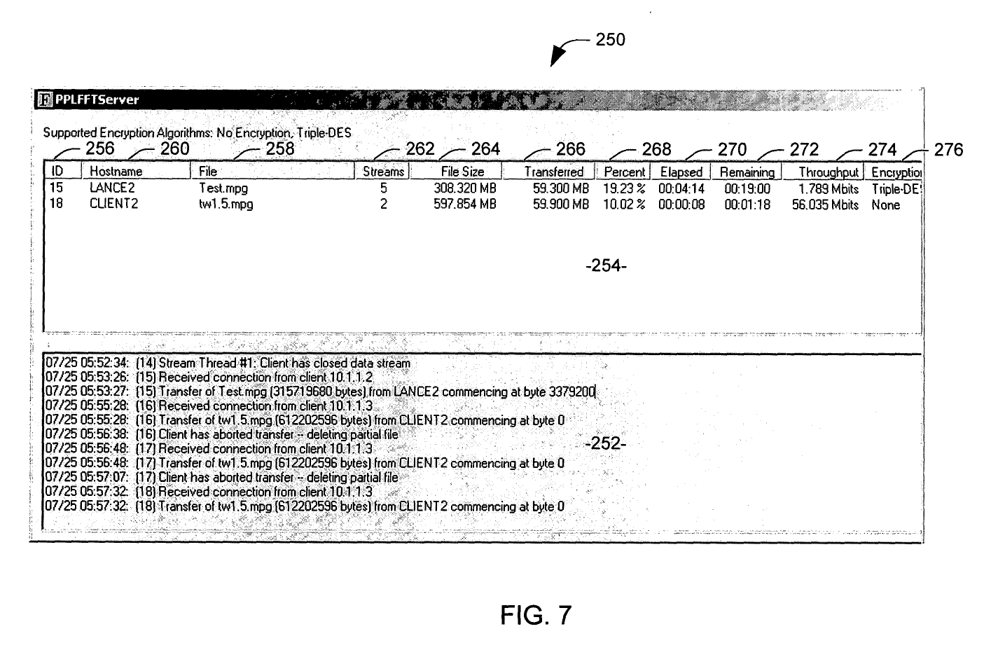

FIG. 7 illustrates a screenshot from an exemplary graphical user interface 250 for the server. The graphical user interface 250 provides status messages to a user within an update window 252. The graphical user interface 250 further displays information concerning each file being received at the server within a manipulatable display 254 comprising a series of columns. In the illustrated implementation, these columns include columns for providing identification information, such as an identification column 256, a filename column 258 and a column for the hostname of the transmitting client 260. The columns further include several columns providing status information, such as a column listing the number of streams used in the transmission 262, a filesize column 264, a raw progress column 266, a percentage progress column 268, an elapsed time column 270, an estimated remaining time column 272, a throughput column 274, and an encryption column 276 listing an encryption scheme associated with the transmitted file. In an exemplary implementation, the file data can be sorted by column to allow the user to find files having desired characteristics (e.g., the file with the shortest estimated time to completion). Additional functionality not shown herein can be provided by means of pull-down or “right-click” menus within the interface 250. For example, additional menus can be provided for providing more detailed information about each transmission or for prematurely ending a particular transmission.

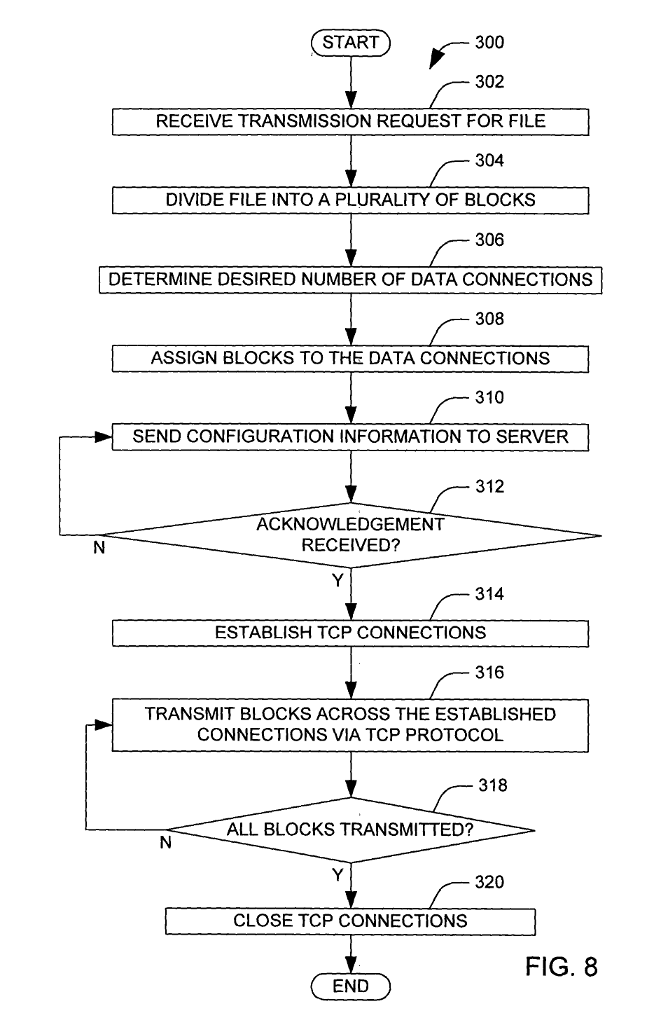

FIG. 8 illustrates an exemplary methodology 300 for transmitting a file in accordance with an aspect of the present invention. The methodology begins at 302, where a file transfer request is received from a user. At 304, the file is divided into a desired number of blocks to facilitate the transfer. The size and number of the blocks can be specified as configuration data from the user or determined by the system as a function of the size of the file and the available bandwidth.

At 306, a desired number of connection or data streams for the transfer is determined. This can be specified by the user as configuration data or determined by the systems as a function of the available bandwidth and other available information. The methodology then proceeds to 308, where one or more blocks are assigned to each of the plurality of data streams. In an exemplary implementation, the blocks are assigned in a round robin progression. In this arrangement, the blocks are assigned sequentially until each stream has a block. All of the assigned blocks are then transferred, and a new set of blocks is assigned to the streams. Alternatively, the blocks can be queued such that each stream receives a new block in the sequence as it finishes its current transfer.

At 310, configuration information is provided to the server. This configuration can include a number of desired connections and the size of the file. Upon receiving the configuration information, the server opens a destination file for the transfer and allocates the necessary resources to establish the desired data transfer connections. The server then sends an acknowledgement to the server, confirming that it has received the configuration data and is prepared for the transfer. At 312, the client awaits the acknowledgement. If the acknowledgement is not received, the methodology returns to 310, where the client resends the configuration data. This can occur if the either the configuration data or the acknowledgement are lost or corrupted in transit.

If the acknowledgement is received, the methodology proceeds to 314, where a plurality of TCP connections are established between the client and the server. The methodology then proceeds to 316, where the client transmits one block across each of the established connections. At 318, it is determined if all of the blocks have been transmitted. If not, the methodology returns to 316, where another set of blocks is transmitted across the TCP connections. If all of the blocks have been sent, the client closes the TCP connections at 320, and the methodology terminates.

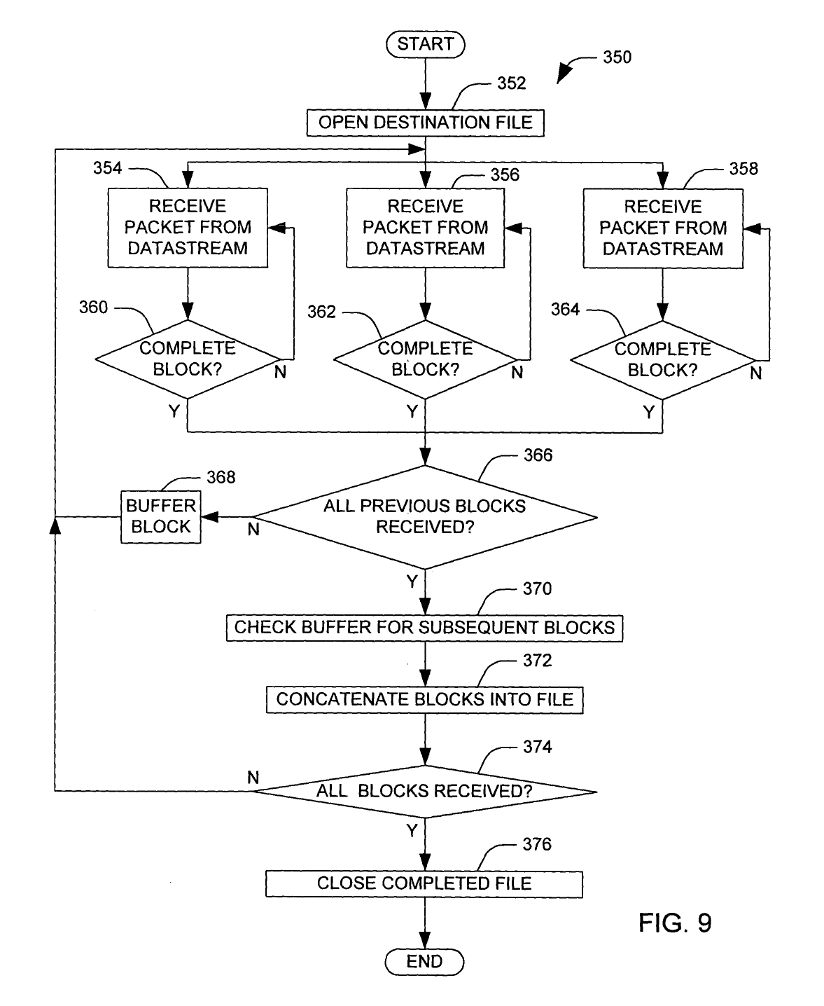

FIG. 9 illustrates an exemplary methodology 350 for receiving a transmitted file in accordance with an aspect of the present invention. It will be appreciated that while the illustrated flow diagram shows three parallel paths of processing, any number of parallel connections can be used within the spirit of the present invention. The methodology begins at 352 where a destination file is opened at the server. The methodology continues in parallel at 354, 356, and 358 where a packet is sent through the data stream. For each data stream, the system determines if an entire packet has been received at decision blocks 360, 362, 364. If not, the methodology returns to the appropriate previous step (i.e., 354, 356, or 358). If the block is completely received in any of the data streams, that process advances to 366.

For each received block, it is determined at 366 if all blocks previous to the received block have received. The transferred blocks represent a source file from a client system, and can be concatenated in a predetermined sequence to form the source file. Thus, the system reads an ordinal identifier associated with the block and determines if all blocks prior to that block in sequence have been received. If the blocks have arrived out of sequence and one or more prior blocks have not been received, the methodology advances to 368 where the block is buffered. The system then returns to one of blocks 354, 356, or 358 to await the arrival of a new block. If all prior blocks have been received, the methodology advances to 370.

At 370, the buffer is checked for blocks subsequent and consecutive to the received block. For example, if block seven is received, the buffer will be checked for block eight. If block eight is found, the buffer will seek block nine, and so forth, until a block within the sequence is found to be missing. The methodology then advances to 372, where the received block is concatenated into the destination file. Concatenating the block into a file can include retrieving any consecutive subsequent blocks found within the buffer as well as any prior blocks within the buffer for concatenation with the received block. The methodology then advances to 374, where it is determined if all of the blocks from the file have been received. If not, the system returns to one of blocks 354, 356, or 358 to await the arrival of another block. If all blocks have been received, the methodology advances to 376, where the completed file is closed and saved. The methodology then terminates.

The methodology does not wait for acknowledgments at a first connection before transmitting subsequent portions of the file at subsequent connection. Thus, because the methodology operates in a parallel manner, the methodology can move data at all times rather than waiting for acknowledgments during the long length of time to transfer the entire file. For example, processing considerations at the client can force the connections to be interleaved, or staggered, with respect to one another. Thus, when one connection is waiting for an acknowledgement, one or more other connections can be transmitting to make use of the bandwidth. Thus, the methodology of the present invention reduces dead time within the system by sharing the available bandwidth among a plurality of connections.

Any reference in the above description to “embodiments” or “implementations” of the invention means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the knowledge of one skilled in the art to effect such feature, structure, or characteristic in connection with other ones of the embodiments. Furthermore, for ease of understanding, certain method procedures can have been delineated as separate procedures; however, these separately delineated procedures should not be construed as necessarily order dependent in their performance. That is, some procedures can be able to be performed in an alternative ordering or simultaneously.

Further, embodiments of the present invention or portions of embodiments of the present invention can be practiced as a software invention, implemented in the form of a machine-readable medium having stored thereon at least one sequence of instructions that, when executed, causes a machine to effect the invention. With respect to the term “machine”, such term should be construed broadly as encompassing all types of machines, e.g., a non-exhaustive listing including: computing machines, non-computing machines, communication machines, etc. Similarly, with respect to the term “machine-readable medium”, such term should be construed as encompassing a broad spectrum of mediums. For example, a non-exhaustive listing can include magnetic medium, such as floppy disks, hard disks, and magnetic tape, and optical medium, such as CD-ROMs and DVD-ROMs.

Using the embodiments of the present invention it is possible to reduce the transmission time required for large files without resorting to the use of faster and more expensive communications equipment. Therefore, utilizing standard communications software and hardware a user would realize a significant improvement in communications performance when transmitting and receiving large files using the aforementioned embodiments of the present invention.

A machine-readable medium includes any mechanism that provides (i.e., stores and/or transmits) information in a form readable by a machine. For example, a machine-readable medium includes read only memory (ROM), random access memory (RAM), magnetic disk storage media, optical storage media, flash memory devices, and any form of electrical, optical, or acoustical propagated signals.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A client system, comprising:
a file partitioner that divides a file into a plurality of blocks; and
a client control application operative to initiate a plurality of Transmission Control Protocol (TCP) connections and to assign each of the plurality of blocks to one of the TCP connection of the plurality of TCP connections, such that each block is transmitted via its assigned connection.

2. The system of claim 1, the plurality of blocks being transmitted to a server system, the server system comprising:
a server control application operative to monitor the plurality of TCP connections and to receive the plurality of blocks via the plurality of TCP connections, each block having an associated ordinal identifier;
a buffer that stores the received blocks; and
a concatenation control that retrieves a received block from the buffer and concatenates the received block into a file once blocks having an ordinal identifier prior to the received block have been received.

3. The system of claim 1, further comprising a buffer that stores the plurality of blocks for subsequent transmission.

4. The system of claim 1, the plurality of blocks being assigned to the plurality of TCP connections in a predetermined order.

5. The system of claim 1, the client control application providing e-mail notification of the status of transmission of the blocks over the plurality of TCP connections to at least one remote location.

6. The system of claim 1, the client control application operative to automatically reinitiate a TCP connection if a TCP connection is prematurely terminated.

7. The system of claim 1, the client control application operative to pause at least one of the plurality of TCP connections to allow a lagging connection access to the available bandwidth.

8. The system of claim 1, the client system further comprising a graphical user interface that provides status information to a user.

9. The system of claim 8, the graphical user interface comprising an abort key that ends the transmission of the plurality of blocks.

10. The system of claim 8, the graphical user interface further comprising a configuration routine that allows a user to specify a bandwidth to be used in the connection.

11. The system of claim 8, the status information comprising at least one of the size of the file, a duration associated with the transmission of the plurality of blocks, a bandwidth value associated with the transmission, and an estimated duration for the transmission to be completed.

12. The system of claim 10, the graphical user interface further comprising a configuration routine that allows a user to specify at least one of, an averaging period used for deriving the estimated duration for the transmission and a number of TCP connections utilized in the transfer.

13. A computer readable medium comprising the system of claim 1.

14. A server system, comprising:
a server control application operative to monitor a plurality of Transmission Control Protocol (TCP) connections and to receive a plurality of blocks via the plurality of TCP connections, each block having an associated ordinal identifier;
a buffer that stores the received blocks; and
a concatenation control that writes received blocks to a destination file once all blocks having an ordinal identifier, prior to the received block, have been written to the file.

15. The system of claim 14, the plurality of blocks being received from a client system, the client system comprising
a file partitioner that divides a source file to create the plurality of blocks; and
a client control application operative to initiate the plurality of TCP connections and to assign each of the plurality of blocks to one of the plurality of TCP connections, such that each block is transmitted via its assigned connection.

16. The system of claim 14, the server control application being operative to extract control data from at least one of the received blocks.

17. The system of claim 14, the concatenation control operative to monitor the buffer for blocks consecutive and subsequent to a received block.

18. The system of claim 14, the server system comprising a graphical user interface that provides status information to a user relating to transmission of the plurality of blocks and/or the concatenation of the received blocks.

19. The system of claim 18, the status information including at least one of the size of the file, an identification associated with a client system transmitting the file, a duration associated with the transmission of the plurality of blocks, a bandwidth value associated with the transmission, and an estimated duration for the transmission to be completed.

20. The system of claim 18, the graphical user interface further comprising a manipulatable display such that a user can organize the status information in a desired manner.

21. A computer readable medium comprising the system of claim 14.

22. A method of transferring a file over a network comprising:
dividing a source file into a plurality of blocks at a first entity;
establishing a plurality of data connections between the first entity and a second entity;
assigning a block from the plurality of blocks to a respective data connection of the plurality of data connections; and
transmitting the plurality of blocks from the first entity to the second entity,
each block being transmitted over its assigned data connection.

23. The method of claim 22, the method further comprising:
concatenating the plurality of blocks, including a first block, into a destination file during the transmission of at least one other block;
concatenating a block received at the second entity when all blocks having an ordinal identifier prior to the received block have been concatenated into the file; and
buffering a block received at the second entity when at least one block having an ordinal identifier prior to the received block has not been concatenated into the file.

24. The method of claim 22, the plurality of data connections utilizing Transmission Control Protocol (TCP) to transmit the assigned blocks.

25. A method of transferring a file from a first entity to a second entity over a network, said method comprising:
transmitting a plurality of blocks from the first entity to the second entity via a plurality of data connections;
concatenating a sequence of blocks, including a first block, into a file during the transmission of at least one other block within the sequence;
concatenating a block received at the second entity when all blocks having an ordinal identifier prior to the received block have been concatenated into the file; and
buffering a block received at the second entity when at least one block having an ordinal identifier prior to the received block has not been concatenated into the file.

26. The method of claim 25, further comprising:
dividing a source file to generate the plurality of blocks at the first entity; and
assigning at least two of the plurality of blocks to each of the plurality of data connections.

27. The method of claim 25, the plurality of data connections utilizing Transmission Control Protocol (TCP) to transmit the assigned blocks.
